(19) United States
(12) Patent Application Publication
(10) Pub. No.: US 2006/0142399 A1
(43) Pub. Date: Jun. 29, 2006

(54) Process for defoaming a composition

(76) Inventor: Dariush Behnam, Rossdorf (DE)

Correspondence Address: JACOBSON HOLMAN PLLC, 400 SEVENTH STREET N.W., SUITE 600, WASHINGTON, DC, 20004, US

(21) Appl. No.: 11/287,218

(22) Filed: Nov. 28, 2005

(30) Foreign Application Priority Data
Nov. 26, 2004 (DE) 10 2004 057 417.0

(51) Int. Cl. B01D 17/05; A23D 7/06

(52) U.S. Cl. 516/143; 426/604

(57) ABSTRACT

The present invention describes a process for defoaming a composition using a wax, primarily of natural origin, where the wax is added to the composition that is heated to the melting temperature of the wax.

When manufacturing foods, products containing water in particular, such as drinks that contain emulsifiers due to their composition, the formation of foam can pose a problem in the production and filling process.

It is known that emulsifiers, polysorbates in particular, are responsible for intensive foam formation and thus negatively affect the speed of the filling processes of modern filling and bottling plants, for example, when filling polysorbate-contain mg drinks.

Hardly any effective defoamers are known so far except a defoaming agent that is available on the market and is a 10% solution of E 471 (a mixture of monoesters, diesters and trimesters of glycerol from cooking fats) in ethanol (with relatively low effectiveness). E 471 is a European Standard.

However, the above-mentioned defoamer has a very short shelf life (six months when stored at 10-20° C.) and is furthermore relatively expensive.

Therefore, the objective underlying the present invention is to suggest an effective, and low-priced alternative that also has a long shelf-life.

For this purpose, the present invention provides a defoaming agent that consists of a wax, primarily of a natural origin where the wax is added to a composition that is heated to the melting temperature of the wax. Beeswax cera alba proves to be particularly favorable for achieving the desired effect or if the slight discoloration of the composition is an irrelevant factor, then cera flava or even candellila wax can be used. The wax is expediently contained in the composition only in a lesser amount of for example, approximately 0.3% by weight to approximately 0.6% by weight. The invention is particularly effective in compositions that contain a substantial amount of an emulsifier such as for example a polyabsorbate, such as polyabsorbate 20 or polyabsorbate 80.

Furthermore, the present invention provides a process for manufacturing the defoaming agent in which a wax, primarily of natural origin is added to a composition that is heated to the melting temperature of the wax and is agitated until the wax dissolves in the composition and the mixture consisting of the wax and the composition is cooled down to room temperature (approximately 20° C.) while continuing to be agitated. The process is accelerated if wax that is already liquefied is added to the temperature-controlled composition. It is advantageous to use cera alba and to heat the composition to approximately 70° C.

Preferred embodiments of the present invention are specified in the appending claims. The present invention is explained more elaborately in the following description on the basis of examples.

### EXAMPLE 1

Polyabsorbate 80 is stirred with cera alba of the amounts of 0.0%, 0.3%, 0.4%, and 0.6% at a temperature of around 70° C. until the wax platelets are dissolved completely in the polysorbate. The mixture consisting of polysorbate and cera alba is slowly cooled down to room temperature while being agitated constantly. The foam formation that occurs during the agitation and its characteristics are entered in columns 1 to 4 of row 1 of table 1.

Thereafter, approximately I g of the polyabsorbate mixture is stirred with cera alba in I liter of non-carbonated drinking water from the public drinking water supply and the decomposition of the foam is entered in column 5 of table 1.

Finally, approximately 7 g of gaseous CO₂ is introduced into I liter of non-carbonated drinking water to which the polysorbate mixture was added as stated above. The decomposition of the foam in terms of time is entered in column 6 of table 1.

### EXAMPLE 2

The procedure and measurements correspond to those specified in example 1. However, polyabsorbate 80 is replaced with a solubizate that consists of 20% by weight of vitamin E and 80% by weight of polyabsorbate 20.

The results are entered in row 2 of table 1. The addition of cera alba in the amount of 0.6% by weight that is not listed in the table yields the same results as an addition of 0.4% by weight of cera alba.

### EXAMPLE 3

Again, the procedure corresponds to that specified in example 1. However, as a comparison, polyabsorbate 80 is replaced with the product E 230 Clear of the ADM brand that contains 66% of polyabsorbate 60, 17% of vitamin E, and 17% of ethanol. The cera alba portion amounted to 0.0%. Furtherimore, example 3 differs from example I with regard to columns 5 and 6 in table 1, row 3 in that 1.176 g of E 230 Clear is stirred with I liter of drinking water.

Table 2 illustrates a comparison of the effect of the commercially available defoaming agent E 471 (addition of 10 mg. to 1 liter of water) to the effect of cera alba of 0.4% by weight from table 1, row 2, based on the example 2, namely an addition of 1 g of solubizate to 1 liter of drinking water (column 2) and also to I liter drinking water having the mentioned CO₂ carbonation (columns 3 and 5).

The superiority of the present invention when compared to the known defoaming agents is evident. The marginally increased viscosity of drinks that contain the defoaming agent according to the present invention is not noticeable subjectively and is therefore insignificant

TABLE 1
Comparison of the foam development of polyabsorbates and/or products consisting thereof with and without cera alba.
Base used in each case of 1 g of raw material/solubizate to 1000 ml. non-carbonated water and water having CO₂.

| | | | COLUMN 3 | COLUMN 4 | COLUMN 5 | COLUMN 6 |
|---|---|---|---|---|---|---|
| | COLUMN 1 | COLUMN 2 | Foam development and characteristics | | Time/Decomposition of foam in minutes | |
| | Raw | Concentration of cera | Non-carbonated | Drinking water | Non-carbonated | Drinking water |
| | material/Solubizate | alba in % | drinking water | having CO₂ | drinking water | having CO₂ |
| 1 | Polyabsorbate 80 | 0.0% | Low foam development | Foam, typical | Immediately | Approx. 20 min. |
| | | 0.3% | Low foam development, low | Low foam development | Immediately | Approx. 7 min. |
| | | | solubility in water | | | |
| | | 0.4% | Very low foam development, | Very low foam | Immediately | Immediately |
| | | | low solubility in water | development | | |
| | | 0.6% | No foam development, low | No foam development | Immediately | Immediately |
| | | | solubility in water | | | |
| 2 | Solubizate | 0.0% | Dissolves properly and | Foam, typical | Immediately | Approx. 20 min. |
| | consisting of | | quickly | | | |
| | vitamin E and 80% | 0.3% | Dissolves properly when | Almost without foam | Immediately | No foam |
| | of polyabsorbate 20 | | agitated | development | | |
| | | 0.4% | Dissolves properly when | Without foam | Immediately | No foam |
| | | | agitated | development | | |
| 3 | Vitamin E 230 Clear | 0.0% | Low foam development, low | Foam formation, stable | Immediately | Approx. 35 min. |
| | of ADM brand | | solubility in water | | | |
| | Batch: EC0503-01 | | | | | |

TABLE 2
Base of 1 g of solubizate consisting of 20% vitamin E and 80% polyabsorbate 20 to 1000 ml. drinking water.

| | | COLUMN 2 | COLUMN 3 | COLUMN 4 | COLUMN 5 |
|---|---|---|---|---|---|
| | | Foam development and characteristics | | Time/Decomposition of foam in minutes | |
| | COLUMN 1 | | Drinking water | Non-carbonated | Drinking water |
| | Defoaming agent | Non-carbonated drinking water | having CO₂ | drinking water | having CO₂ |
| 1 | Without any | Dissolves properly and quickly | Foam, typical | immediately | Approx. 20 min. |
| 2 | 10 mg. Defoamer | Dissolves properly and quickly | Foam, typical | Immediately | Approx. 20 min. |
| | (E 471) | | | | |
| 3 | 0.4% cera alba | Dissolves properly and quickly | Without foam | Immediately | No foam |
| | | | development | | |

1. Process for defoaming a composition using a wax, primarily of natural origin, where the wax is added to the composition that is heated at the melting temperature of the wax.

2. Process pursuant to claim 1, in which the mixture made out of wax and the composition is agitated until the wax dissolves in the composition and the mixture is cooled down to room temperature while continuing to be agitated.

3. Process pursuant to claim 1, in which beeswax, cera alba, cera flava, or candellila wax is used.

4. Process pursuant to claim 1, in which cera alba or cera flava is added in small amounts to the composition, to foods and/or provisions.

5. Process pursuant to claim 1 in which approximately 0.3% by weight up to approximately 0.6% by weight of the wax is added to the composition.

6. Process pursuant to claim 1 in which the composition contains a substantial amount of an emulsifier.

7. Process pursuant to claim 6, in which the emulsifier having an HLB value ranging between 8 and 18, for example, a polyabsorbate such as polyabsorbate 20 or polyabsorbate 80 is used.

8. Process pursuant to claim 1 in which approximately 1 g of the composition is added to approximately 1 liter of water, in carbonated form, if necessary.

9. Process pursuant to claim 1 in which liquefied wax is added to the temperature-controlled composition.

10. Process pursuant to claim 1 in which the composition is heated to approximately 70° C.

11. Process pursuant to claim 1 in which a solubilizate consisting of an emulsifier, vitamins and cera alba and/or cera flava and/or candellila wax is used as the composition.

12. Process pursuant to claim 11 in which a solubizate consisting of approximately 80% of polyabsorbate 20 and approximately 20% of tocopherol such as, e.g., α-tocopherol, DLα-tocopherol, vitamin E and/or mixed tocopherol and cera alba and/or cera flava and/or candellila wax are used.

13. Use of a wax primarily of natural origin such as for example, cera alba, cera flava, or candellila wax as the agent for defoaming compositions.
